(19) United States
(12) Patent Application Publication
(10) Pub. No.: US 2017/0270162 A1
(43) Pub. Date: Sep. 21, 2017

(54) QUERY OPTIMIZATION METHOD IN DISTRIBUTED QUERY ENGINE AND APPARATUS THEREOF

(71) Applicant: ELECTRONICS AND TELECOMMUNICATIONS RESEARCH INSTITUTE, Daejeon (KR)

(72) Inventors: Tae-Whi LEE, Daejeon (KR); Sung-Soo KIM, Daejeon (KR); Jong-Ho WON, Daejeon (KR); Moon-Young CHUNG, Daejeon (KR)

(21) Appl. No.: 15/251,167

(22) Filed: Aug. 30, 2016

(30) Foreign Application Priority Data
Mar. 17, 2016 (KR) 10-2016-0032122

(51) Int. Cl. G06F 17/30

(52) U.S. Cl. CPC G06F 17/30469; G06F 17/30498

(57) ABSTRACT

The following description relates to a query optimization method in distributed query engine and an apparatus thereof. A query optimization method according to an exemplary embodiment includes establishing a query plan based on query; classifying data to be included in result data of a high level operation from result data of a low level operation as a first data to be used for intermediate operations existing between the low level operation and the high level operation and a second data not to be used for the intermediate operations, based on the query plan; and modifying the query plan for the second data not to be an input value for the intermediate operations

### CROSS REFERENCE TO RELATED APPLICATION

This application claims the benefit under 35 U.S.C. §119(a) of Korean Patent Application No. 10-2016-0032122 tiled on Mar. 17, 2016 in the Korean Intellectual Property Office, the entire disclosure of which is incorporated herein by reference for all purposes.

### BACKGROUND

1. Technical Field

The following description relates to a query optimization method and a query optimization apparatus in a distributed query engine.

2. Description of Related Art

Works to improve a business through worthwhile insight acquired by analyzing large-scale data has become an important task in today's industries. The large-scale data analysis requires various dataset processings so that various distribution processing frameworks such as MapReduce, Hadoop and Spark, etc. have been introduced to process big data within a reasonable time. The distribution processing framework has become a key factor for the large-scale data analysis. However, data analysts are under pressure to unfamiliar programmings. Distributed query engines, which support SQL (structured query language) which is a standard language or declarative query languages which are similar thereto, have emerged in order to reduce this burden. Examples of the distributed query engine include Hive, Impala, Presto, Drill, Tajo and SparkSQL, etc.

In a distributed query engine, data is processed by nodes in a cluster. Intermediate result calculated by a certain node in accordance with a query is needed to be redistributed. For example, intermediate result is needed to be redistributed based on a certain field value to process a join operation which combines records having the same certain field values among several datasets. In the case of a sort operation, intermediate result is needed to be redistributed based on a sort target field value range.

When there are many data fields for final query results or a size of the data field is big, a size of intermediate result becomes bigger since corresponding fields are included in the intermediate result from the early stage so that disk and network input/output costs to redistribute the intermediate result increase and performance is deteriorated.

### RELATED ART

US 2014/0195558 (System and method for distributed database query engines)

US 2014/0188841 (Method for two-stage query optimization in massively parallel processing database clusters)

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the following description provide measures to prevent unnecessary data redistribution in a query processing of a distributed query engine.

According to one general aspect, a query optimization method includes establishing a query plan based on query; classifying data to be included in result data of a high level operation from result data of a low level operation as a first data to be used for intermediate operations existing between the low level operation and the high level operation and a second data not to be used for the intermediate operations, based on the query plan; and modifying the query plan for the second data not to be an input value for the intermediate operations.

The modifying the query plan may include modifying the query plan when transferring cost of the second data is equal to or higher than a threshold value.

The low level operation may be the lowest level operation among the operations existing in the query plan.

The high level operation may be the highest level operation among the operations existing in the query plan.

The query optimization method may further include adding a join operation configured to join a final intermediate result from a final intermediate operation existing at the highest level among the intermediate operations and the second data.

The low level operation may be a scan operation.

The high level operation or the intermediate operation may be a join operation or an alignment operation.

A hash join method or a nested loop join method may be applied to the join operation when a sort operation exists among the intermediate operations.

According to another general aspect, a query optimization apparatus includes a memory; and a processor in communication with the memory, the processor operable to execute instructions which cause the processor to: establish a query plan based on queries; classify data to be included in result data of a high level operation from result data of a low level operation as a first data to be used for intermediate operations existing between the low level operation and the high level operation and a second data not to be used for the intermediate operations, based on the query plan; and modify the query plan for the second data not to be an input value for the intermediate operations.

The apparatus may further include instructions that cause the processor to: modify the query plan when transferring cost of the second data is equal to or higher than a threshold value.

The low level operation may be the lowest level operation among the operations existing in the query plan.

The high level operation may be the highest level operation among the operations existing in the query plan.

The apparatus may further include instructions that cause the processor to: add a join operation configured to join the final intermediate result from the final intermediate operation existing at the highest level among the intermediate operations and the second data.

The low level operation may be a scan operation.

The high level operation or the intermediate operation may be a join operation or a sort operation.

The apparatus may further include instructions that cause the processor to: apply a hash join method or a nested loop join method to the join operation when a sort operation exists among the intermediate operations.

Accordingly, an amount of data to be redistributed in a query processing can be reduced. In addition, disk and network input/output costs in a query processing can also be reduced.

### BRIEF DESCRIPTION OF DRAWNIGS

Hereinafter, the following description will be described with reference to embodiments illustrated in the accompanying drawings. To help understanding of the following description, throughout the accompanying drawings, identical reference numerals are assigned to identical elements. The elements illustrated throughout the accompanying drawings are mere examples of embodiments illustrated for the purpose of describing the following description and are not to be used to restrict the scope of the following description.

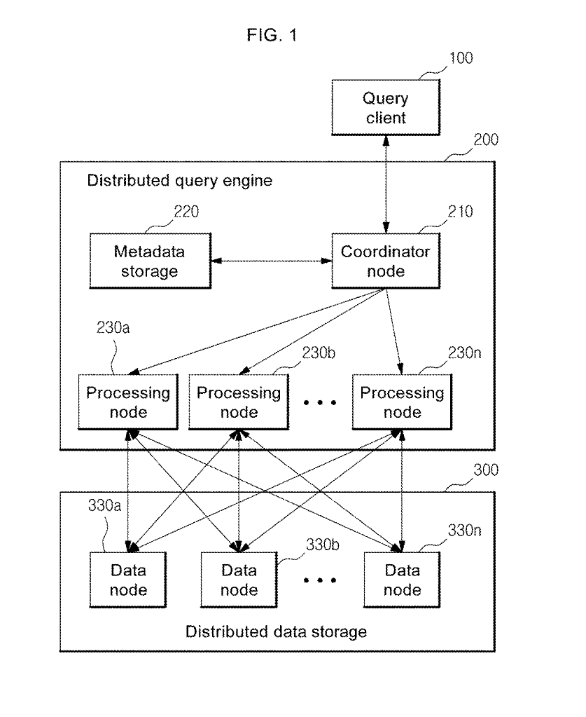

FIG. 1 is a diagram illustrating an example of a distributed query engine in which embodiments of the following description are applied.

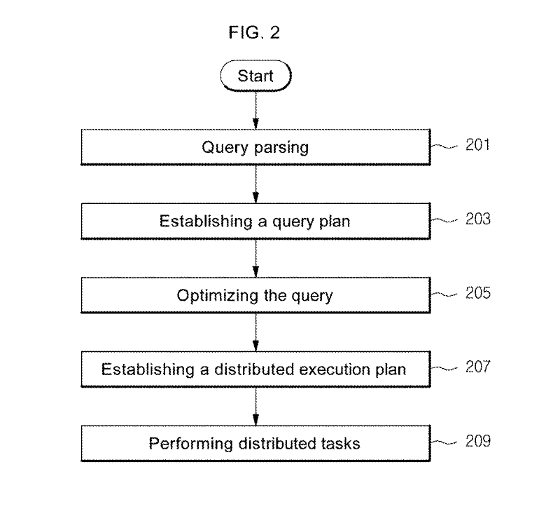

FIG. 2 is a flow chart illustrating an example of a query processing method in a distributed query engine.

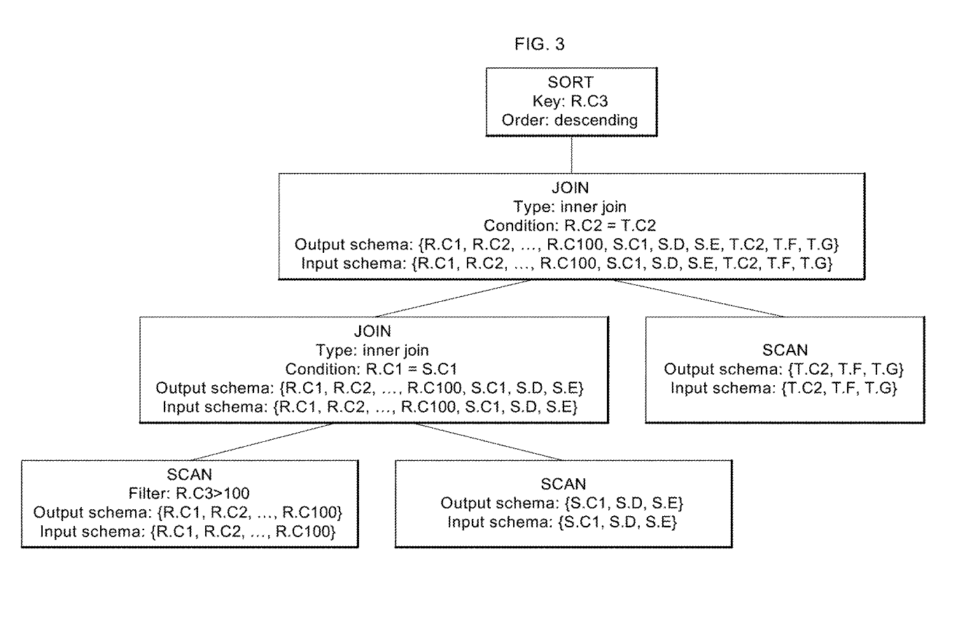

FIG. 3 is a diagram illustrating an example of a query plan in accordance with a query of Table 1.

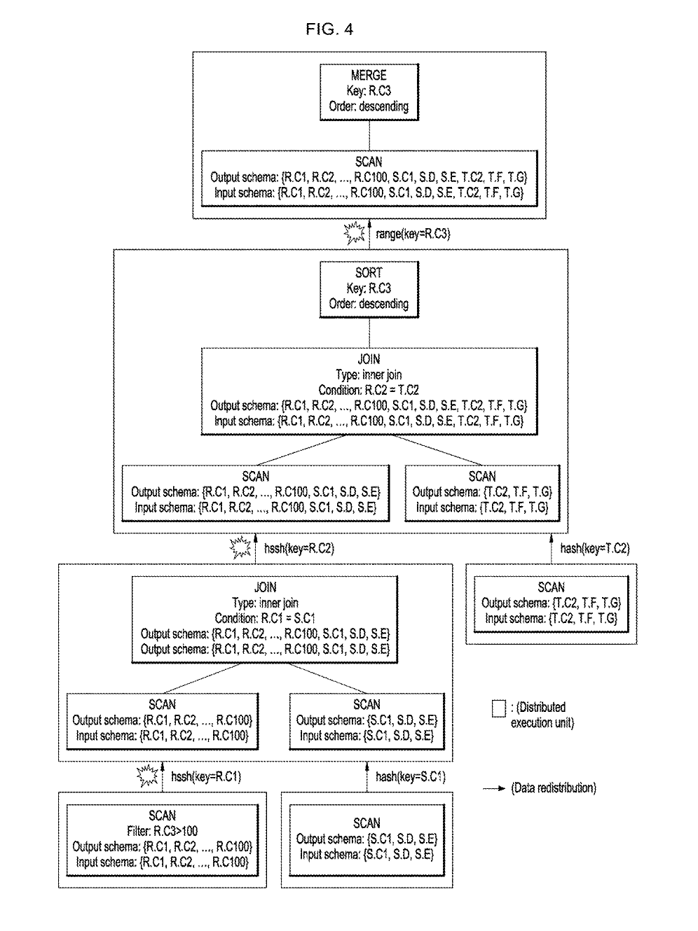

FIG. 4 is a diagram illustrating an example of a distributed execution plan in accordance with the query plan shown in FIG. 3.

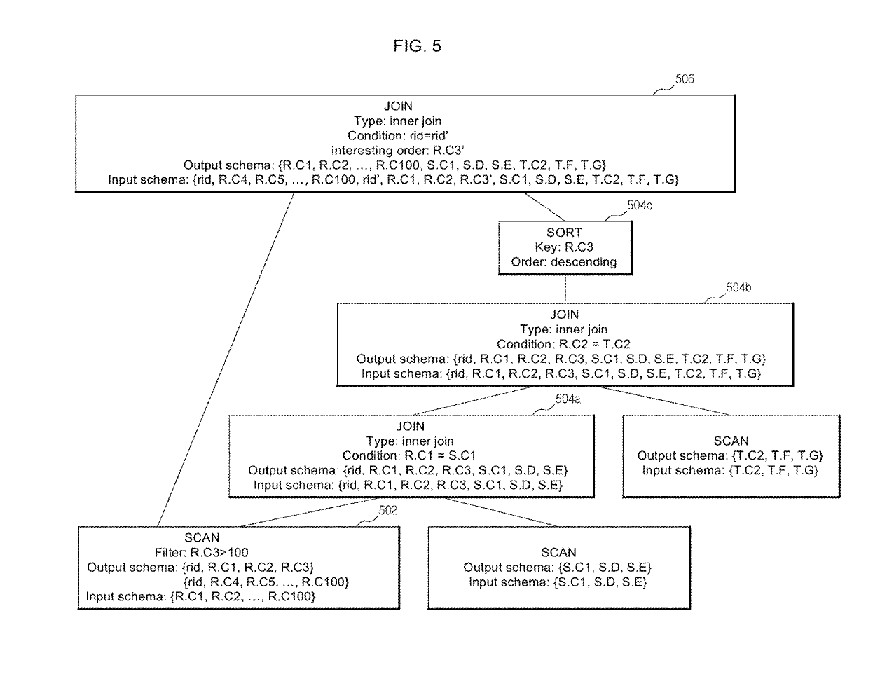

FIG. 5 is a diagram illustrating an example of a query optimization in accordance with the query plan shown in FIG. 3.

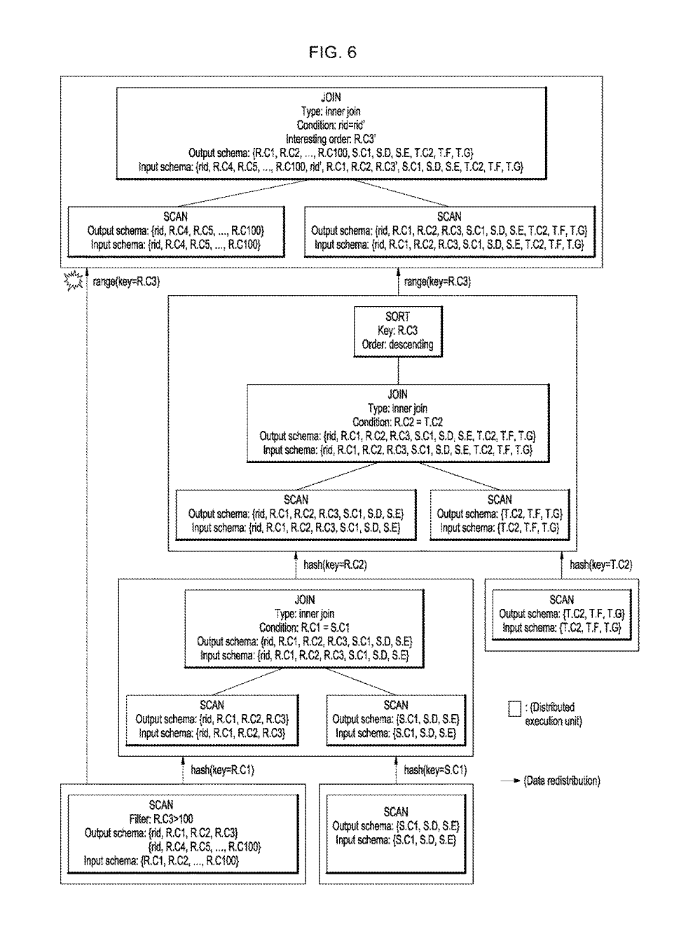

FIG. 6 is a diagram illustrating an example of a distributed execution plan established in accordance with the optimized query as shown in FIG. 5.

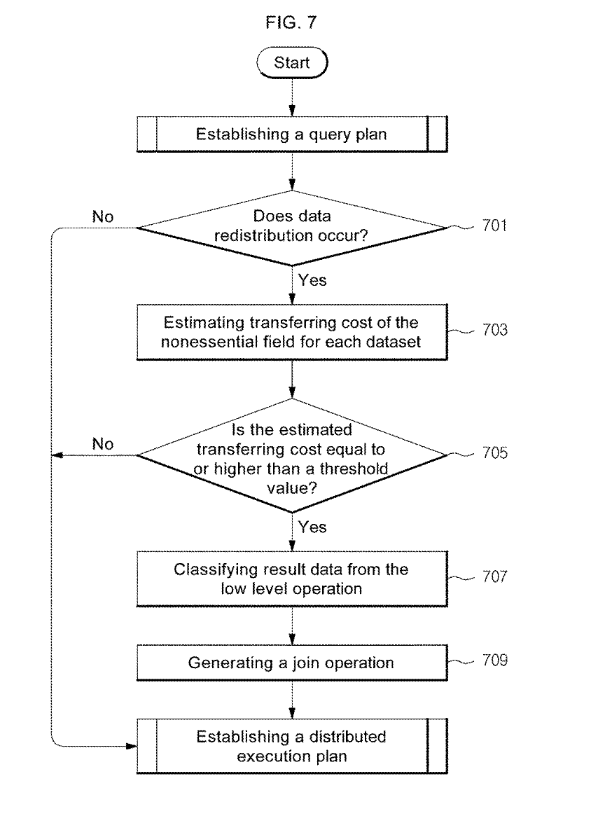

FIG. 7 is a flow chart illustrating an example of a query optimization method.

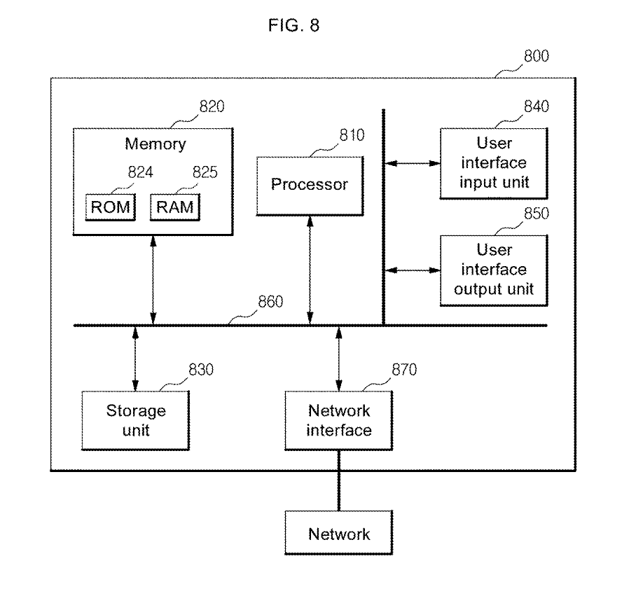

FIG. 8 is a diagram illustrating an example of a query optimization apparatus.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Since there can be a variety of permutations and embodiments of the following description, certain embodiments will be illustrated and described with reference to the accompanying drawings. This, however, is by no means to restrict the following description to certain embodiments, and shall be construed as including all permutations, equivalents and substitutes covered by the ideas and scope of the following description.

Throughout the description of the present disclosure, when describing a certain technology is determined to evade the point of the present disclosure, the pertinent detailed description will be omitted.

Embodiments of the following description provide a method for query optimization to reduce cost for redistributing intermediate results which can be caused during the query processing process.

The method for query optimization according to embodiment of the following description can be used widely in general distributed query engines and further be used in systems having various storage types including a row-based file system.

FIG. 1 is a diagram illustrating an example of a distributed query engine in which embodiments of the following description are applied. At least one of the components in FIG. 1 can be omitted.

A distributed query engine 200 may include a coordinator node 210, a metadata storage 220 and at least one processing nodes 230a, 230b, . . . , 230n.

The coordinator node 210 may establish a query plan and perform query optimization based on the established query plan. A query to be used for establishing the query plan may be received from a query client 100.

The metadata storage 220 may store information required for system operations, for example, data schema, user information and statistical information for the query optimization.

The processing nodes 230a, 230b, . . . , 230n may perform distributed operation in accordance with the query plan (query plan which may be query optimized) established by the coordinator node 210. At least one of the processing nodes 230a, 230b, . . . , 230n may operate as a coordinator lode. The processing nodes 230a, 230b, 230n may access to a distributed data storage 300 to perform tasks assigned to themselves. The processing nodes 230a, 230b, . . . , 230n may read data stored in the distributed data storage 300 or record data in the distributed data storage 300.

The distributed data storage 300 may include at least one of data nodes 330a, 330b, . . . , 330n. The data nodes 330a, 330b, . . . , 330n may store data and provide data to the processing nodes 230a, 230b, . . . , 230n when there is an access from the processing nodes 230a, 230b, . . . , 230n, update pre-stored data, or store new data. At least one of the data nodes 330a, 330b, . . . , 330n may function as a processing node.

FIG. 2 is a flow chart illustrating an example of a query processing method in a distributed query engine. At least one of the steps in FIG. 2 can be omitted.

In step 201, a distributed query engine may receive a query and perform query parsing. For example, the distributed query engine may parse whether the query is correct or not, and covert the query to the expression which is needed for processing the query.

In step 203, the distributed query engine may establish a query plan. The distributed query engine may check information needed for processing the query by referring to the metadata storage, and determine whether there is any semantic error in the query to establish the query plan.

In step 205, the distributed query engine may optimize the query based on the established query plan. For example, the distributed query engine may optimize the query by estimating cost required for processing the query or applying query plan modification rule which is able to provide better performance to the query plan. Cost estimation may be made based on various cost models.

In step 207, the distributed query engine may establish a distributed execution plan. For example, the distributed query engine may determine how to perform distribution processing for operations in the optimized query.

In step 209, the distributed query engine may distribute the query based on the established distributed execution plan to process the query.

Examples of embodiments of the following description relate to a query optimization step. For example, examples of embodiments may allow query optimization to reduce disk and network input/output costs which are caused during the distributed execution plan establishing process and the distribution process.

Conventional methods, used to reduce disk and network input/output costs which are caused during the distribution process, have focused on excluding data which is not included in the final query result from earlier step. Examples of these methods include predicate pushdown, projection pushdown, semijoin, bloomjoin and the like. However, data which is included in the final query result may not be the data which is not directly used for operations which any processing node performs. Thus, if query optimization is performed not to redistribute the data, which is not directly used for operations which any processing node performs, to the processing node, disk and network input/output costs may be significantly reduced. For example, it is assumed that 3 large datasets R, S and T have form of tables of R(C1, C2, C3, . . . , C100), S(C1, D, E), and T(C2, F, G), respectively. It is also assumed that fields contained in C3 column of the dataset R are numeral strings and the rest fields are character strings. It is assumed that a query in Table is processed under the assumption.

TABLE 1

```
SELECT *
FROM R, S, T
WHERE R.C1 = S.C1
  AND R.C2 = T.C2
  AND R.C3 > 100
ORDER BY C3 DESC;
```

Query optimization may be conducted differently in accordance with statistical information of data, but a logical query execution plan shown in FIG. 3 may be derived by a conventional query optimization method under the assumption of that data is large enough.

FIG. 3 is a diagram illustrating an example of a query plan in accordance with a query of Table 1.

A query plan shown in FIG. 3 is a plan driving the final query result by sorting intermediate results generated by joining datasets(R, S) using, join keys(R.C1, S.C1) and joining datasets(R, T) using join keys(R.C2, T.C2) based on a C3 field. Here, an operation in accordance with a result selecting condition(R.C3>100) may be carried in an early stage to reduce size of intermediate results to be redistributed. A distributed execution plan may be established based on the query plan.

FIG. 4 is a diagram illustrating an example of a distribution execution plan established in accordance with the query plan shown in FIG. 3.

A distributed execution plan may include a plan to allocate independently executable distributed execution units to each processing node and to redistribute intermediate results derived from each processing node into higher processing nodes. Referring to the distributed query execution plan shown in FIG. 4, it is noted that the intermediate result of dataset R containing many fields is redistributed several times. Since all fields of the dataset R are redistributed, disk and network input/output costs are very high.

FIG. 5 is a diagram illustrating an example of a query optimization in accordance with the query plan shown in FIG. 3.

Referring to FIG. 5, intermediate results(R.C1, R.C2, R.C3, R.C4, R.C5, . . . , R.C100) by a low level operation 502 scanning dataset R are classified into 2 sets. One set(R.C1, R.C2, R.C3) may include data (hereinafter, referred to as a first data) to be used for intermediate operations(504a, 504b, 504c) existing between the low level operation 502 and a high level operation 506, and the other set(R.C3, R.C4, R.C5, . . . , R.C100) may include data(hereinafter, referred to as a second data) not to be used for intermediate operations(504a, 504b, 504c).

The second data is data which is to be included in the result of the high level operation 506 but is not to be used for intermediate operations(504a, 504b, 504c). Thus, an amount of data to be redistributed in a distributed query processing process may be reduced by ensuring the second data not to be an input value for the intermediate operations(504a, 504b, 504c).

On the other hand, since the second data among the intermediate results from the low level operation 502 is not used as the input value for the intermediate operations(504a, 504b. 504c), it is needed to combine the final intermediate result from the final intermediate operation 504c, which is located on the top of the intermediate operations(504a, 504b, 504c), and the second data.

Thus, the operation 506 may be added to combine the data. The operation 506 may combine the final intermediate result from the final intermediate operation 504c and the second data. The operation 506 may be a join operation.

For the operation 506, a record identifier(rid) field which indicates a record uniquely may be included in each of the set in which the first data is included and the set in which the second data is included. When a field having a unique value for each record exists in the fields of the dataset, the unique value may be used as a record identifier.

The operation 506 may be executed with consideration of an interesting order to keep the sort result of the previous operation. Hash join method and nested-loop join method may be used to keep the son result of the previous operation.

FIG. 6 is a diagram illustrating an example of a distribution execution plan established in accordance with the optimized query as shown in FIG. 5.

Referring to FIG. 6, it is noted that the number of redistributions of the fields included in R.C4, R.C5, . . . , R.C100 among the fields of the dataset R is significantly reduced when it is compared with that shown in FIG. 4.

FIG. 7 is a flow chart illustrating an example of a query optimization method. At least one of the steps in FIG. 7 can be omitted. It is assumed that a query plan is already established in the embodiments described with FIG. 7.

In step 701, a distributed query engine may analyze a query plan to determine whether data redistribution will occur or not. Occurring data redistribution may mean that at least a part of result data(intermediate result) from any low level operation existing in the query plan is an input value for a high level operation.

The low level operation may be the lowest level operation of the operations existing in the query plan or any one of the operations existing between the lowest level operation and the highest level operation. The high level operation may be the highest level operation of the operations existing in the query plan or any one of the operations existing between the low level operation and the highest level operation. The low level operation may be a scan operation and the high level operation may be a join operation or a sort operation. When data redistribution occurs, it proceeds to step 703.

In step 703, the distributed query engine may classify result data from the low level operation as an essential field and a nonessential field and estimate transferring cost of the nonessential field for each dataset. The essential field may be data which is used as an input value for intermediate operations existing between the low level operation and the high level operation, and the nonessential field may be data which is not used as an input value for intermediate operations. The intermediate operations may be a join operation or a sort operation.

In step 705, the distributed query engine may determine whether the transferring cost of the nonessential field estimated for each dataset is equal to or higher than a threshold value. That the transferring cost of the nonessential field is equal to or higher than a threshold value means disk and network input/output costs for data redistributions are high.

In step 707, the distributed query engine may classify result data from the low level operation. Classifying may be performed for each dataset of which the estimated transferring cost of the nonessential field is equal to or higher than the threshold value. The distributed query engine may modify the query plan for the nonessential field of result data from the low level operation not to be used as an input value for intermediate operations. In other words, the distributed query engine may modify the query plan for only the essential field of result data from the low level operation to be used as an input value for intermediate operations.

In step 709, the distributed query engine may generate a join operation to join the nonessential field of result data of low level operation and the final intermediate result from the final intermediate operation.

After the query optimization in accordance with the above-mentioned method, a distributed execution plan may be established and distributed tasks allocation may be provided.

Exemplary embodiments of the present disclosure may be implemented in a computing system, for example, a computer readable recording medium. As shown in FIG. 8, a computing system 800 may include at least one of at least one processor 810, a memory 820, a storing unit 830, a user interface input unit 840 and a user interface output unit 850 in which they may be communicate with each other through a bus 860. The computing system 800 may further include a network interface 870 to connect to a network. The processor 810 may be a CPU or semiconductor device which executes processing commands stored in the memory 820 and/or the storing unit 830. The memory 820 and the storing unit 830 may include various types of volatile/non-volatile storage media. For example, the memory may include ROM 824 and RAM 825.

Accordingly, the exemplary embodiment of the present disclosure can be implemented by the method which the computer is implemented or in non-volatile computer recording media stored in computer executable instructions. The instructions can perform the method according to at least one embodiment of the present disclosure when they are executed by a processor.

What is claimed is:

1. A query optimization method in a distributed query engine, the method comprising:
establishing a query plan based on query;
classifying data to be included in result data of a high level operation from result data of a low level operation as a first data to be used for intermediate operations existing between the low level operation and the high level operation and a second data not to be used for the intermediate operations, based on the query plan; and
modifying the query plan for the second data not to be an input value for the intermediate operations.

2. The query optimization method of claim 1, wherein the modifying the query plan comprises modifying the query plan when transferring cost of the second data is equal to or higher than a threshold value.

3. The query optimization method of claim 1, wherein the low level operation is the lowest level operation among the operations existing in the query plan.

4. The query optimization method of claim 1, wherein the high level operation is the highest level operation among the operations existing in the query plan.

5. The query optimization method of claim 1, further comprising adding a join operation configured to join a final intermediate result from a final intermediate operation existing at the highest level among the intermediate operations and the second data.

6. The query optimization method of claim 1, wherein the low level operation is a scan operation.

7. The query optimization method of claim 1, wherein the high level operation or the intermediate operation is a join operation or a sort operation.

8. The query optimization method of claim 1, wherein a hash join method or a nested loop join method is applied to the join operation when a sort operation exists among the intermediate operations.

9. A query optimization apparatus comprising:
a memory; and
a processor in communication with the memory, the processor operable to execute instructions which cause the processor to:
establish a query plan based on query;
classify data to be included in result data of a high level operation from result data of a low level operation as a first data to be used for intermediate operations existing between the low level operation and the high level operation and a second data not to be used for the intermediate operations, based on the query plan; and
modify the query plan for the second data not to be an input value for the intermediate operations.

10. The query optimization apparatus of claim 9, further comprising instructions that cause the processor to: modify, the query plan when transferring cost of the second data is equal to or higher than a threshold value.

11. The query optimization apparatus of claim 9, wherein the low level operation is the lowest level operation among the operations existing in the query plan.

12. The query optimization apparatus of claim 9, wherein the high level operation is the highest level operation among the operations existing in the query plan.

13. The query optimization apparatus of claim 9, further comprising instructions that cause the processor to: add a join operation configured to join the final intermediate result from the final intermediate operation existing at the highest level among the intermediate operations and the second data.

14. The query optimization apparatus of claim 9, wherein the low level operation is a scan operation.

15. The query optimization apparatus of claim 9, wherein the high level operation or the intermediate operation is a join operation or a sort operation.

16. The query optimization apparatus of claim 9, further comprising instructions that cause the processor to: apply a hash join method or a nested loop join method to the join operation when a sort operation exists among the intermediate operations.
